(19) United States
(12) Patent Application Publication
(10) Pub. No.: US 2013/0062403 A1
(43) Pub. Date: Mar. 14, 2013

(54) TECHNICAL DEVICE AND SYSTEM FOR PROVIDING TECHNICAL INFORMATION FOR A TECHNICAL DEVICE

(71) Applicants: Andreas BERSCHNEIDER, Amberg (DE); Oliver SEHN, Regensburg (DE)

(72) Inventors: Andreas BERSCHNEIDER, Amberg (DE); Oliver SEHN, Regensburg (DE)

(73) Assignee: SIEMENS AKTIENGESELLSCHAFT, Munich (DE)

(21) Appl. No.: 13/605,212

(22) Filed: Sep. 6, 2012

(30) Foreign Application Priority Data
Sep. 9, 2011 (DE) 102011082415.4

(51) Int. Cl. G06K 7/10; G06K 19/06

(52) U.S. Cl. 235/375; 235/494

(57) ABSTRACT

A technical device embodied for installation in a technical plant is disclosed. In at least one embodiment, the technical device includes a surface on which a two-dimensional barcode is arranged, wherein the surface is arranged on the technical device such that the two-dimensional barcode can be read off by a mobile barcode reading device after installation of the technical device in the technical plant. A system for providing technical information for a technical device is further disclosed, which is embodied for installation in a technical plant.

### PRIORITY STATEMENT

The present application hereby claims priority under 35 U.S.C. §119 to German patent application number DE 102011082415.4 filed Sep. 9, 2011, the entire contents of which are hereby incorporated herein by reference.

### FIELD

The invention generally relates to a technical device, which is embodied for installation in a technical plant. The invention further generally relates to a system for providing technical information for a technical device, which is embodied for installation in a technical plant.

### BACKGROUND

Technical devices, which are embodied for installation in a technical plant, are widely known. Particularly in the field of building installation, a plurality of different technical devices, in particular installation devices, is installed in various plants, such as for instance control cabinets.

On account of the large product portfolio of technical devices, it is very difficult and time-consuming, particularly for end users, but also for installers or sales people, to obtain technical information, such as for instance handbooks, operating instructions, certificates, scale drawings, 3D models, device circuit diagrams, frequently asked questions etc. Therefore, in the event of a service for instance, it is currently only possible for the end user or other information-seeking person to acquire the desired technical information by way of hardcopies, for instance handbooks, which are disposed in the vicinity of the technical devices, or by way of specific websites on the Internet and/or specific databases.

Hardcopies, such as operating instructions or handbooks, can get lost quickly or get dirty. It is also difficult to even find the correct hardcopy since a large number of various technical devices, such as for instance circuit breakers or automatic cutouts are arranged in a control cabinet for instance.

On the other hand, the information seeker is generally obliged independently to obtain technical information from the various Internet websites or databases of the technical device provider. This search is frequently unsuccessful, since on account of the vast product portfolio of large companies, the customer only acquires the technical information relating to the sought technical device with difficulty via the central website of the corresponding company. It is in particular frequently very difficult and time-consuming to click through the websites of a provider of technical devices to source the desired technical information relating to a specific technical device.

For this reason the end users of the technical devices, but also installers or sales people, frequently contact the sales contact person, technical support or even the central telephone hotline of the product provider. This nevertheless frequently results in long waiting times and increased costs for the information seekers.

### SUMMARY

In at least one embodiment, the provision and acquisition of technical information is improved, relating to a technical device which is embodied for installation in technical plants. In particular, the acquisition of technical information relating to a technical installation device is to be made possible for an information seeker in a simple, rapid and cost-effective fashion.

At least one embodiment is directed to a technical device and/or a system for providing technical information relating to the technical device. Further features and details of the invention result from the subclaims, the description and the drawings. In this way, features and details which are described in conjunction with the inventive technical device, naturally also apply in conjunction with an embodiment of the inventive system and in each instance vice versa, so that reference is or can be made alternately in respect of the disclosure of the individual inventive aspects.

According to the first aspect of an embodiment of the invention, a technical device is embodied for installation in a technical plant. The technical device has a surface, on which a two-dimensional barcode is arranged, wherein the surface is arranged on the technical device such that after installation of the technical device into the technical plant, the barcode can be read off by means of a mobile barcode reading device. A technical installation device embodied in such a way enables simple acquisition of technical information relating to the technical device by an information seeker, such as for instance an end user, an installer or a sales person. The visible arrangement of the barcode following installation of the technical device ensures that the barcode can be read out by a mobile barcode reading device.

The advantageous embodiments and/or developments of the invention which are explained above and/or reproduced in the subclaims can be used in this way individually or in any communication with one another in an inventive technical device and/or in a system for providing technical information for a technical device.

### BRIEF DESCRIPTION OF THE DRAWINGS

The invention and its developments as well as its advantages are described in more detail below with the aid of drawings, in which.

FIG. 1 shows a schematic representation of a front view of an installation device in building technology, which is developed in accordance with an embodiment of the inventive construction principle,

FIG. 2 shows a schematic representation of the installation device according to FIG. 1 in a side view,

FIG. 3 shows a schematic representation of a system for providing technical installations for a technical device, which is embodied in accordance with an embodiment of the inventive construction principle.

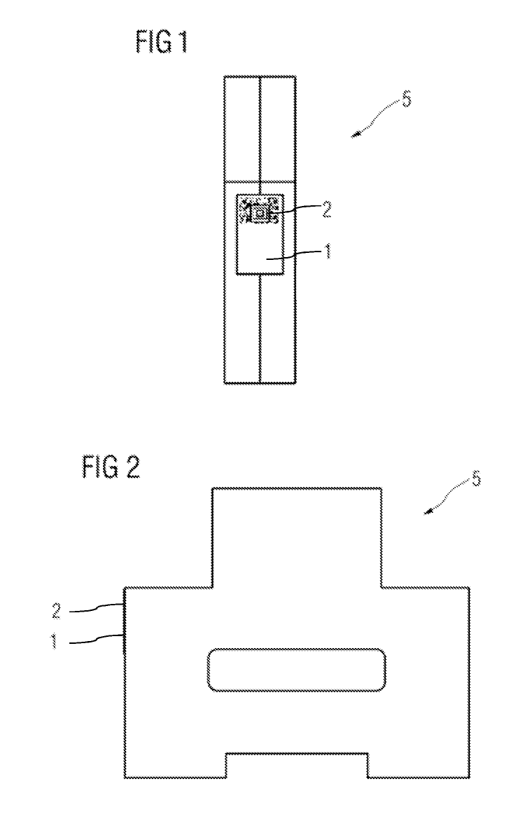

Elements with the same function and mode of operation are provided with the same reference characters in FIGS. 1 to 3.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

According to the first aspect of an embodiment of the invention, a technical device is embodied for installation in a technical plant. The technical device has a surface, on which a two-dimensional barcode is arranged, wherein the surface is arranged on the technical device such that after installation of the technical device into the technical plant, the barcode can be read off by means of a mobile barcode reading device. A technical installation device embodied in such a way enables simple acquisition of technical information relating to the technical device by an information seeker, such as for instance an end user, an installer or a sales person. The visible arrangement of the barcode following installation of the technical device ensures that the barcode can be read out by a mobile barcode reading device.

After reading out the barcode by way of a mobile barcode reading device, for instance a mobile terminal, such as a mobile telephone, a PDA etc., with a barcode reading function, the information seeker can obtain information relating to the technical device in a simple and rapid fashion. What is crucial in technical devices of this type is that the two-dimensional barcode is arranged on the exterior of the technical device such that after installation of the technical device in a technical plant, it is accessible and can be read off by a mobile barcode reading device. The information seeker can herewith immediately obtain technical information relating to the technical device. It is advantageous in this way if the mobile barcode reading device is also embodied to represent the technical information.

The two-dimensional barcode is embodied in particular as a square matrix made of black and white points, which represent the encoded data in a binary fashion. Special markers in three of the four corners of the square specify the orientation. The data in the two-dimensional barcode is protected by an error-correcting code. Even if a small percentage of the two-dimensional barcode is destroyed, it can still be decoded.

According to a preferred further development of an embodiment of the invention, provision can be made in the technical device for the surface through the base of a depression to be embodied on the exterior of the technical device. The two-dimensional barcode is herewith protected on the exterior of the technical device. It ensures that the two-dimensional barcode, which can be press-molded or glued for instance, is not damaged or cannot get lost.

Alternatively, provision can to this end be made in a technical device for the surface on the front face of an elevation to be arranged on the exterior of the technical device. As a result of an elevation being provided on the exterior of the technical device, it can be ensured that the two-dimensional barcode arranged on the front face of the elevation can be reliably read off by a mobile barcode reading device if the technical device is in the installed state. Since technical devices in technical plants are frequently arranged very close to one another and/or above one another, an arrangement of the two-dimensional barcode of this type ensures that an information seeker can reliably read out the two-dimensional barcode by way of a mobile barcode reading device.

The technical device, which is embodied for installation in a technical plant, can be embodied very differently. The technical device is particularly preferably an installation device in building technology. Installation devices of this type are generally installed in building technology in control cabinets, as a result of which they are sometimes only accessible with difficulty. It is therefore advantageous for installation devices of this type to have a surface upon which a two-dimensional barcode is arranged so as to be readable. The technical device and/or the installation device is preferably an electric switching device, in particular an automatic cutout or a circuit breaker. Furthermore, the technical device and/or the installation device can be embodied as a dimmer switch, a clock timer, a multi-functional automatic light, a latching relay, a dimmer, a motion sensor, a meter reader or a time relay. On account of the variety of products in the context of technical devices, in particular in building technology, with technical devices embodied in this way, it is possible for information seekers to obtain technical information relating to the corresponding technical installation device in a simple, rapid and cost-effective manner.

According to a second aspect of an embodiment of the invention, a system is disclosed for providing technical information for a technical device, which is embodied for installation in a technical plant. In this way the system comprises a technical device, which is embodied according to the first aspect of an embodiment of the invention, a technical plant for accommodating the technical device, a computing unit having a storage unit, in which technical information relating to the technical device is stored, wherein the technical information is linked to the barcode on the technical device, and a mobile barcode reading device, which is embodied to read the barcode. The mobile barcode reading device can be connected to the computing unit so as to communicate data in order to transmit the read-out two-dimensional barcode to the computing unit and to transfer technical information from the computing unit to the barcode reading device. The provision of technical information, in particular of handbooks, operating instructions, certificates, scale drawings, 3D models, device circuit diagrams, frequently asked questions etc. relating to a technical installation device, can be implemented in a simple, quick and cost-effective fashion for an information seeker, like for instance an end user, an installer or a sales person, using a system of this type.

The information seeker can therefore read off and/or scan the two-dimensional barcode which is accessible after installation of the technical device in a technical plant by way of a mobile barcode reading device. The barcode reading device sends the read-off two-dimensional barcode to a computing unit, in which the technical information linked to the two-dimensional barcode is provided. The computing unit sends the technical information provided back to the barcode reading device, by way of which the technical information can be displayed. In this process the technical information can be reproduced acoustically by the barcode reading device.

A system in which the barcode reading device has a display for indicating the technical information assigned to the read-out two-dimensional barcode is particularly preferred. The information seeker can herewith obtain information relating to the technical device directly in the vicinity of the technical device, the information being displayed on the display of the barcode reading device. A complicated search for technical information relating to a technical device on Websites of a provider of the technical device is not necessary. A huge advantage of displaying technical information on the display of the barcode reading device is that this information can be constantly read off by the information seeker. This herewith ensures that the information seeker is able to obtain the technical information both correctly and completely.

According to a particularly preferred further development of an embodiment of the invention, provision can be made in a system for the barcode reading device to be a mobile communication terminal with a barcode reading functionality. The mobile communication terminal may for instance be a mobile telephone, a PDA or a table PC. The technical information relating to the corresponding technical device can be provided on these types of mobile communication terminals at no charge for instance. The information seeker obtains the correspondingly prepared technical information presented on the mobile communication device for the two-dimensional barcode read-in and transmitted to the computing unit. This technical information can be made available to the information seeker in various languages.

The computing unit of the system comprises a storage unit for storing technical information of the technical device. The computing unit is particularly preferably part of the World Wide Web.

According to a further preferred further development of an embodiment of the invention, provision can be made in a system for the computing unit and the barcode reading device, in particular the mobile communication terminal, to be embodied for radio transmission of data. This herewith ensures particularly simple communication between the computing unit and the barcode reading device.

At least one embodiment of the inventive system has the same advantages as have been described in detail with respect to at least one embodiment of an inventive technical device.

FIG. 1 shows a schematic representation of a front view of an installation device 5 in building technology, which is embodied according to the inventive construction principle. The installation device 5 represents a technical device, which is embodied for installation in a technical plant. The installation device 5 has a surface 1, on which a two-dimensional barcode 2 is arranged. The surface 1 and thus the two-dimensional barcode 2 are arranged on the technical device 5 such that the two-dimensional barcode 2 can be read off by a mobile barcode reading device after installation of the technical device 5 in the technical plant. The surface 1 and thus the two-dimensional barcode 2 are preferably arranged on a front or front face of the technical device, here the installation device 5 in the building technology. The surface 1 is particularly preferably embodied through the base of a depression on the exterior of the technical device 5. A two-dimensional barcode 2 arranged on the surface 1 is arranged on the technical device 5 in a protected manner.

FIG. 2 shows a schematic representation of the side view of the technical device 5 according to FIG. 1. The installation device 5 is embodied for installation in a control cabinet of the building technology. In particular, the technical device 5 can be fastened on a rail, in particular a top hat rail.

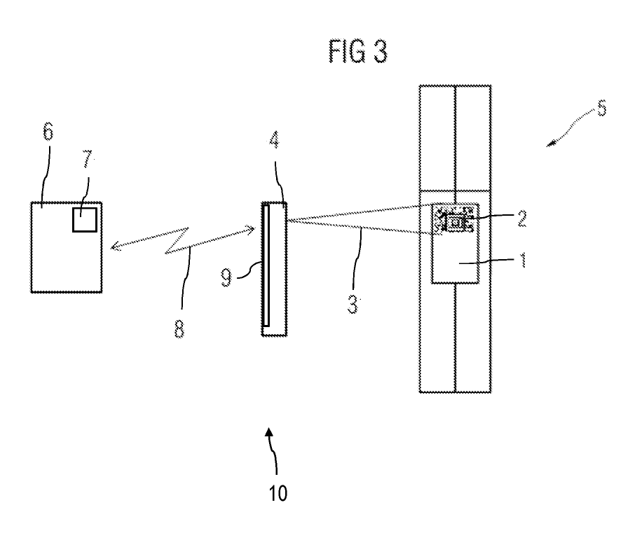

FIG. 3 shows a schematic representation of a system 10 for providing technical information for a technical device 5, which is embodied for installation in a technical plant. The system 10 has a technical device 5, which is embodied for installation in a technical plant and has a surface 1 upon which a two-dimensional barcode 2 is arranged. The surface 1 of the technical device 5 is arranged in this way on the technical device 5 such that the two-dimensional barcode 2 can be read off by a mobile barcode reading device 4 of the system 10 after installation of the technical device 5 into the technical plant. “Can be read off” here means that the two-dimensional barcode 2 can be read off and/or scanned by way of a camera of the mobile barcode reading device 4. The system 1 also comprises a technical plant for accommodating the technical device 5. The technical plant may be a control cabinet in the building technology for instance.

Furthermore, the system 10 comprises a computing unit 6 with a storage device 7, in which technical information relating to the technical device 5 is stored. The technical information can be handbooks, operating instructions, certificates, scale drawings, 3D models, device circuit plans etc. for instance. The technical information which is stored in the storage unit 7 is linked to the two-dimensional barcode 2 of the technical device 5. The mobile barcode reading device 4 is embodied to read 3 the two-dimensional barcode 2.

Furthermore, the mobile barcode reading device 4 of the system 10 can be connected to the computing unit 6 so as to communicate data for transmitting 8 the read-out two-dimensional barcode 2 to the computing unit 6 and for transmitting 8 technical information from the computing unit 6 to the mobile barcode reading device 4. The mobile barcode reading device 4 is preferably embodied as a mobile communication terminal with a barcode reading functionality. In particular, the mobile communication terminal 4 can be a mobile telephone, a PDA, a table PC etc. In order to indicate the information assigned to the read-out two-dimensional barcode 2, the mobile barcode reading device 4 has a display 9. Both the computing unit 6 and also the mobile barcode reading device 4 are preferably embodied for radio transmission 8 of data and/or information.

The technical device 5 shown in FIGS. 1 and 2 and/or the system shown in FIG. 3 enables the provision and acquisition of technical information relating to a technical device 5, which is embodied for installation in technical plants, to be improved. In particular, it is possible for an information seeker, for instance an end user, an installer or a sales person, to acquire the technical information relating to a technical installation device 5 in a simple, rapid and cost-effective manner by way of a technical device 5 of this type and/or by way of a system 10 described in FIG. 3.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims.

Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE CHARACTERS

1 surface
2 two-dimensional barcode
3 scan/read off
4 mobile barcode reading device
5 technical installation device
6 computing unit
7 storage unit
8 data transmission/radio transmission
9 display
10 system

What is claimed is:

1. A technical device which is embodied for installation in a technical plant, comprising:
a surface on which a two-dimensional barcode is arranged, the surface being arranged on the technical device such that the two-dimensional barcode is readable by a mobile barcode reading device after installation of the technical device in the technical plant.

2. The technical device of claim 1, wherein the surface is embodied through a base of a depression on an exterior of the technical device.

3. The technical device of claim 1, wherein the surface is arranged on a front face of an elevation on an exterior of the technical device.

4. The technical device of claim 1, wherein the technical device is an installation device of building technology.

5. The technical device of claim 1, wherein the technical device is an electrical switching device, in particular a cutout switch or a circuit breaker.

6. A system for providing technical information for a technical device, embodied for installation in a technical plant, the system comprising:
a technical device, embodied according to claim 1;
a technical plant for accommodating the technical device; and
a computing unit including a storage unit, in which the technical information relating to the technical device is stored, wherein the technical information is linked to the two-dimensional barcode on the technical device, the two-dimensional barcode being readable by a mobile barcode reading device and the mobile barcode reading device being connectable to the computing unit so as to communicate data in order to transmit the read-out two-dimensional barcode to the computing unit and to transmit technical information from the computing unit to the mobile barcode reading device.

7. The system of claim 6, wherein the mobile barcode reading device comprises a display for displaying the information assigned to the read-out two-dimensional barcode.

8. The system of claim 6, wherein the mobile barcode reading device is a mobile communication terminal with a barcode reading functionality.

9. The system of claim 6, wherein the computing unit and the mobile barcode reading device are embodied for radio transmission of data.

10. The technical device of claim 5, wherein the electrical switching device is a cutout switch or a circuit breaker.

11. The system of claim 7, wherein the mobile barcode reading device is a mobile communication terminal with a barcode reading functionality.

12. The system of claim 7, wherein the computing unit and the mobile barcode reading device are embodied for radio transmission of data.
